(19) United States
(12) Patent Application Publication
(10) Pub. No.: US 2026/0165310 A1
(43) Pub. Date: Jun. 18, 2026

(54) AEROSOL SPRAY DEVICE, INSECTICIDE COMPOSITION, AND METHOD OF USE

(71) Applicant: UNITED INDUSTRIES CORPORATION, Earth City, MO (US)

(72) Inventors: Hemant S. Betrabet, Earth City, MO (US); Jeffrey Crull, McFarland, WI (US); Jeffrey L. Harwig, Franklin, WI (US); William Mathias, Middleton, WI (US); Josh Matta, Columbia, MD (US); Alex J. Wall, St. Louis, MO (US); Oliver Ilagan, Earth City, MO (US); Kristina Thompson, Earth City, MO (US)

(73) Assignee: UNITED INDUSTRIES CORPORATION, Earth City, MO (US)

(21) Appl. No.: 19/465,983

(22) Filed: Jan. 30, 2026

Related U.S. Application Data
(63) Continuation of application No. PCT/US2024/040777, filed on Aug. 2, 2024.
(60) Provisional application No. 63/517,401, filed on Aug. 3, 2023.
(60) Provisional application No. 63/517,460, filed on Aug. 3, 2023.

(51) Int. Cl. A01M 7/00; A01N 25/06; A01N 43/30; A01N 53/00; A01P 7/02; A01P 7/04; B65D 83/28

(52) U.S. Cl. CPC A01M 7/005; A01M 7/0017; A01N 25/06; A01N 43/30; A01N 53/00; A01P 7/02; A01P 7/04; B65D 83/28; A01M 2200/01

(57) ABSTRACT

An aerosol spray device includes a canister that holds a propellant under pressure and a reservoir that holds an active solution, the reservoir being discrete relative to the canister. A venturi system includes a manifold body coupled to the canister and defining a first flow path, and a venturi nozzle coupled to the reservoir and defining a second flow path. The disclosure also includes compositions and methods for eliminating insects by diffusing in a room or space.

### CROSS-REFERENCE TO RELATED APPLICATIONS

This patent application is a continuation of International Patent Application No. PCT/US2024/040777, entitled “AEROSOL SPRAY DEVICE, INSECTICIDE COMPOSITION, AND METHOD OF USE”, filed Aug. 2, 2024, which claims priority to and benefit of U.S. Provisional Patent Application No. 63/517,460 filed Aug. 3, 2023, and titled “AEROSOL SPRAY DEVICE AND METHOD,” and U.S. Provisional Patent Application No. 63/517,401 filed Aug. 3, 2023, and titled “INSECTICIDE COMPOSITION FOR USE IN A DIFFUSION APPLICATION.” Each of the above-identified patent applications are hereby incorporated by reference in their entirety.

### BACKGROUND

This disclosure relates generally to aerosol spray devices and, more particularly, to an aerosol spray device having discrete chambers for a propellant and an active solution, and a venturi nozzle that increases atomization and projection of the active solution for dispersion from the aerosol spray device.

Insecticide compositions are used to control or eliminate insect populations. They can be classified based on their chemical structure and mode of action, which determines their effectiveness against different insect species. Each type of insecticide has a mode of action, target insects, and environmental risks, which may be considered when selecting and applying them. Insecticides require topical or physical application, either by administration to a trap or device, or by applying the insecticide to a surface or known space of pest infestation. This presents challenges when treating an insect infestation where infestation may be spread throughout a space and where insects and eggs may be hiding on surfaces that are hard to reach. Insects have natural behaviors that help them seek out shelters or harborages. This helps insects avoid treatments and prolongs the infestation. Fogging insecticides may be helpful but also present challenges. Not all insecticides are effective in a diffusion application, distributing the proper active concentration evenly through the room is difficult, putting insecticide compositions into the air can cause sensitivities or health concerns for humans or animals in the area, and insecticides may not be effective against all insect life stages.

At least some known aerosol spray devices are used with insecticides and configured to aerosolize an active ingredient, such as pyrethrin, into a fine spray that shoots in an upwards direction from the device and settles down in the area around the device. These devices may be called bug bombs, foggers, and the like. A button that starts the aerosolization is typically disposed directly adjacent to a nozzle that disperses the spray. This configuration may make the aerosol spray device difficult to use. Additionally, the active ingredient is typically stored within the same chamber as the propellant, thus making control of the atomization and dispersion of the active ingredient difficult. Accordingly, improvements to aerosol spray devices are desired.

### SUMMARY

The present disclosure relates generally to aerosol spray devices having a propellant and an active solution with independent flow paths, as well as an insecticide composition for use in a diffusion application, and methods of use. A venturi system is configured to atomize the active solution via the propellant and project the active solution in a dispersion area around the device. An actuation mechanism is configured to actuate the propellant flow path and create a continuous activation flow for the aerosol spray device. By separating the propellant and the active solution within the aerosol spray device, the venturi system facilitates increased control of the atomization and projection of the active solution.

In an aspect, the technology relates to an aerosol spray device including: a canister configured to hold a propellant under pressure; a reservoir configured to hold an active solution, the reservoir being separate from the canister; a manifold body having a first end and a second end defining a first flow path, the first end coupled in fluid communication with the canister; a venturi nozzle having a first end and a second end defining a second flow path, the first end coupled in fluid communication with the reservoir and the second end supported at least partially within the second end of the manifold body and within the first flow path, wherein the second flow path proximate the second end of the venturi nozzle has a constricted diameter relative to the second flow path proximate the first end of the venturi nozzle; and an actuator configured to selectively actuate flow of the propellant through the first flow path, wherein upon activation, the propellant is channeled towards the second end of the manifold body and at least partially around an exterior of the second end of the venturi nozzle, and wherein when the propellant expels from the second end of the manifold body, the propellant siphons the active solution through the second flow path and out of the second end of the venturi nozzle such that the active solution is atomized for dispersion from the aerosol spray device.

In an example, a nozzle cap is coupled to the second end of the manifold body, the nozzle cap defining an orifice configured to at least partially receive the second end of the venturi nozzle. In another example, the first flow path is completely independent from the second flow path until an exterior of the nozzle cap. In still another example, the actuator is remotely positioned relative to the nozzle cap. In yet another example, a cover is configured to couple to an end of the canister, the reservoir, the manifold body, the venturi nozzle, and the actuator, are all at least partially disposed within the cover. In an example, the actuator is a button that locks into an open flow configuration.

In another example, the propellant does not include volatile organic compounds. In still another example, the propellant is non-flammable. In yet another example, the canister includes between 2 and 3.5 ounces of the propellant. In an example, the propellant has a pressure from 60 to 85 pounds per square inch. In another example, the active solution includes at least one active and at least one solvent. In still another example, the active solution includes from 2 to 7 grams of the at least one active.

In another aspect, the technology relates to a venturi nozzle for an aerosol spray device including: a body having a first end and an opposite second end defining a longitudinal axis, an inlet orifice defined at the first end and an outlet orifice defined at the second end, a flow path is defined between the inlet orifice and the outlet orifice extending along the longitudinal axis, wherein the inlet orifice has a larger diameter than the outlet orifice, and wherein the body is formed from a plastic based material; and a flange integrally formed at the second end of the body and extending radially outward relative to the longitudinal axis, the flange defining at least one aperture, wherein the flange is longitudinally offset from the outlet orifice.

In an example, a diameter of the outlet orifice is 20-30% of the size of a diameter of the inlet orifice. In another example, the first end and the second end define a longitudinal length, the diameter of the outlet orifice 10-20% of the longitudinal length. In still another example, the flow path includes a transition section disposed between the first end and the second end, the transition section located closer to the outlet orifice than the inlet orifice. In yet another example, flange is an annular flange extending around the body, the annular flange having an outer diameter that is larger than any outer diameter of the body. In an example, the at least one aperture has a diameter that is larger than the diameter of the outlet orifice and smaller than the diameter of the inlet orifice.

In another example, the body includes an annular groove shaped and sized to receive a sealing member. In still another example, the body includes a radial shoulder disposed proximate the second end, the radial shoulder having one end taper radially inwards as the radial shoulder extends towards the flange. In yet another example, the annular groove is adjacent the radial shoulder opposite from the taper.

In another aspect, the technology relates to a method of assembling an aerosol spray device including: providing a canister holding a propellant under pressure; coupling a venturi system to the canister, the venturi system including a manifold body having a first end and a second end defining a first flow path, the first end of the manifold body coupled in fluid communication to the canister, the venturi system further including a reservoir holding an active solution discrete from the reservoir, a venturi nozzle having a first end and a second end defining a second flow path, the first end of the venturi nozzle coupled in fluid communication with the reservoir and the second end of the venturi nozzle supported at least partially within the second end of the manifold body and within the first flow path, the second flow path proximate the second end of the venturi nozzle having a constricted diameter relative to the second flow path proximate the first end of the venturi nozzle, and an actuator configured to selectively actuate flow of the propellant through the first flow path; and at least partially covering the venturi system on the canister with a cover, wherein the second end of the venturi nozzle and the actuator at least partially extending from the cover, the actuator positioned remote from the venturi nozzle.

In some embodiments, the insecticide composition may include a pyrethroid, such as phenothrin in an amount of about 0.1 wt % to about 20 wt %. The composition may also include a synergist, such as piperonyl butoxide in an amount of about 0.1 wt % to about 10 wt %. The composition may also include a solvent system. The amount of solvent system may vary, but the composition may include the solvent system in an amount of about 80 wt % to about 93 wt % of the total composition. The composition may further comprise additional additives or features, such as thickeners, fragrances, carriers, or other additives.

When used, the insecticide composition is preferably diffused so that it has a concentration in the air of about 0.0001 g/ft³ to about 0.00075 g/ft³. When the composition settles out of the air and onto a surface, the composition has a concentration on the surface of about 0.001 g/ft² to about 0.0075 g/ft².

In embodiments, the composition disclosed herein may be effective against a variety of insects, including but not limited to ants, cockroaches, fleas, tick, flies, and others. The composition can be effective against all life-stages of a pest, from eggs to adult pests.

In some embodiments, the composition is used in a method to eliminate insects where the composition is diffused into a room. The composition may be diffused into a room using a fogger, a humidifier, an aerosol, or a diffuser. The composition includes an insecticide, a solvent, and a synergist. In some embodiments, the composition comprises mineral spirits and mineral oils as the solvent, piperonyl butoxide as the synergist, and phenothrin as the active. The insecticide composition may be diffused in air. The diffusion of the insecticide may eliminate insects with an efficacy of about 90% to about 100%, within about 48 hours to about 72 hours of treatment. In another embodiment, the diffusion of the insecticide may eliminate insects with an efficacy of about 90% to about 100%, within 96 hours of treatment.

In another embodiment, the disclosed composition has a viscosity of 5 cps to 200 cps. In some embodiments, the composition includes a thickener to increase the viscosity of the composition.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure. The drawings are not to scale and are intended for use in conjunction with the explanations in the following detailed description. Examples of the present disclosure will hereinafter be described in conjunction with the appended drawings, wherein like numerals denote like elements.

FIG. 1 is a perspective view of a first embodiment of an aerosol spray device and in accordance with the principles of the present disclosure.

FIG. 2 is an exploded, perspective view of the aerosol spray device shown in FIG. 1.

FIG. 3 is a cross-sectional, perspective view of the aerosol spray device shown in FIG. 1.

FIG. 4 is a perspective view of a cap of the aerosol spray device shown in FIG. 1.

FIG. 5 is a perspective view of a reservoir of the aerosol spray device shown in FIG. 1.

FIG. 6 is a perspective view of a manifold body of the aerosol spray device shown in FIG. 1.

FIG. 7 is a perspective view of a nozzle cap of the aerosol spray device shown in FIG. 1.

FIG. 8 is a perspective view of a venturi nozzle of the aerosol spray device shown in FIG. 1.

FIG. 9 is a cross sectional view of the venturi nozzle shown in FIG. 8.

FIG. 10 is a partial cross-sectional view of the aerosol spray device shown in FIG. 1.

FIG. 11 illustrates a flowchart depicting a method of assembling an aerosol spray device.

FIG. 12 is a perspective view of a second embodiment an aerosol spray device and in accordance with the principles of the present disclosure.

FIG. 13 is an exploded, perspective view of the aerosol spray device shown in FIG. 12.

FIG. 14 is a perspective view of a venturi nozzle of the aerosol spray device shown in FIG. 12.

FIG. 15 is a perspective view of a manifold body of the aerosol spray device shown in FIG. 12.

FIG. 16 is a perspective view of a reservoir of the aerosol spray device shown in FIG. 12.

FIG. 17 is a perspective view of a cap of the aerosol spray device shown in FIG. 12.

FIG. 18 is a cross-sectional view of a third embodiment of an aerosol spray device in accordance with the principles of the present disclosure.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

Throughout this description, references to orientation (e.g., front (ward), rear (ward), top, bottom, back, right, left, upper, lower, etc.) of the components of the aerosol spray device relate to their position when standing upright on an underlying surface and are used for ease of description and illustration only. No restriction is intended by use of the terms regardless of how the components of the aerosol spray device are situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

### Aerosol Spray Device

In the examples described herein, an aerosol spray device includes a canister of pressurized propellant, a fluid reservoir of an active solution, and a venturi system configured to disperse the active solution from the device through atomization and projection. The venturi system is supported on top of the canister defining a propellant flow path configured to channel the propellant from the canister and through the venturi system. The fluid reservoir of the active solution is connected to the venturi system and includes an independent active solution flow path. An actuator is configured to actuate the propellant flow path in order to create a siphon at the active solution flow path, and atomize and project the active solution upon discharge from the aerosol spray device. By controlling atomization and projection of the active solution, increased dispersion area saturation and efficiency is provided.

Uncoupling the propellant canister from the active solution reservoir via the venturi system facilitates atomization and projection of the active solution upon dispersion from the aerosol spray device. As used herein, atomization of the active solution includes control of the particle size of the active solution, and projection of the active solution includes control of the velocity of the active solution particles. Based at least partially on the particle size and velocity of the active solution, the dispersion area for the active solution can be defined. Additionally or alternatively, the use of the venturi system enables for the actuator to be disposed remote from the outlet orifices of the propellant and the active solution, thereby increasing user performance.

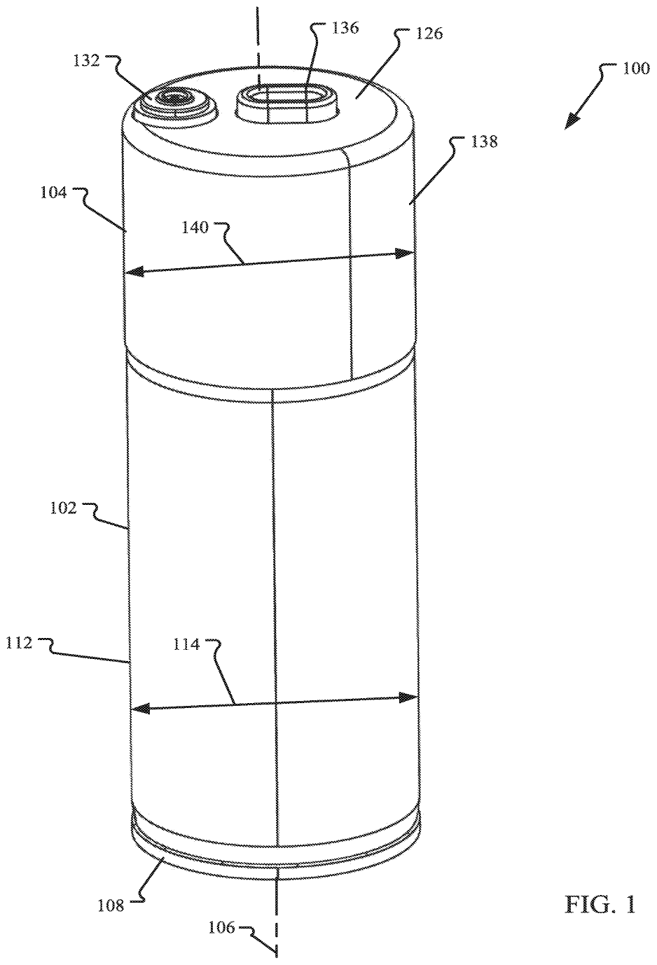

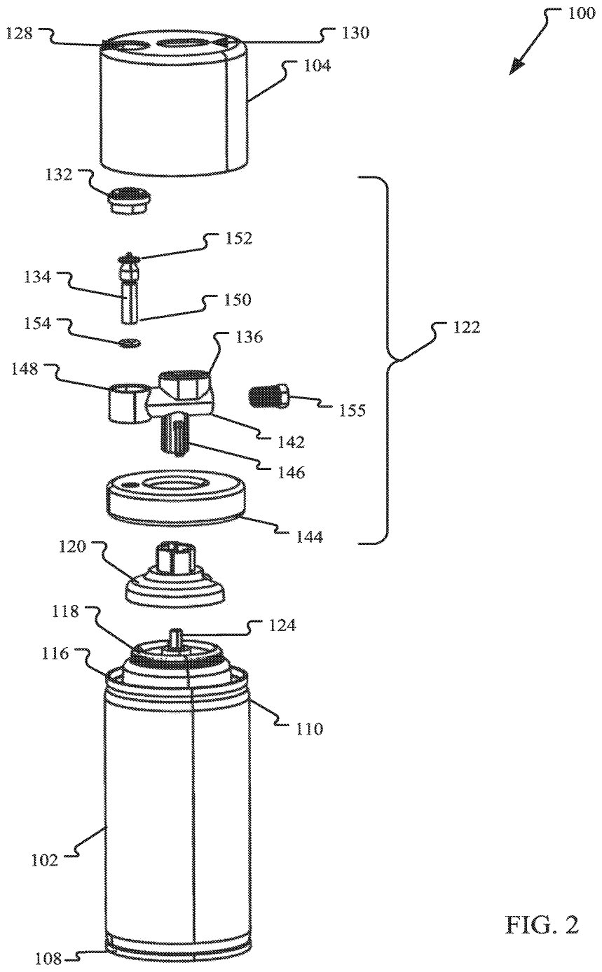

FIG. 1 is a perspective view of a first embodiment of an aerosol spray device 100. FIG. 2 is an exploded, perspective view of the aerosol spray device 100. Referring concurrently to FIGS. 1 and 2, the aerosol spray device 100 includes a canister 102 and a cover 104 configured to couple together along a longitudinal axis 106. The canister 102 is substantially cylindrical in shape with a bottom end 108 and a top end 110 disposed along the longitudinal axis 106. A cylindrical side wall 112 extends between the bottom and top ends 108, 110, and has an outer diameter 114. The bottom end 108 is configured to be placed on an underlying surface (not shown) and allow the aerosol spray device 100 to stand upright on its own and not tip over. The top end 110 has an outer flange 116 that in some examples is configured to couple to the cover 104. An inner flange 118 that is radially inside of the outer flange 116 is configured to couple to a cap 120 that supports a venturi system 122 for selectively projecting an atomized active solution from the aerosol spray device 100. The venturi system 122 is disposed at least partially within the cover 104. A nipple 124 is disposed within the inner flange 118. In some examples, the nipple 124 may include a valve to allow propellant to flow from the canister 102.

The cover 104 has a top wall 126 defining a nozzle opening 128 and a discrete actuator opening 130. The venturi system 122 includes a nozzle cap 132 and a venturi nozzle 134 that extend at least partially through the nozzle opening 128. The nozzle cap 132 and the venturi nozzle 134 define the outlet orifices for the aerosol spray device 100 and allow for external discharge from the aerosol spray device 100. An actuator 136 extends through the actuator opening 130 and is accessible from the exterior of the aerosol spray device 100. In the example, the actuator 136 is discrete from the outlet orifices and is positioned remote therefrom. In other examples, the actuator 136 may extend from a sidewall 138 of the cover 104 as required or desired. The sidewall 138 of the cover 104 has an outer diameter 140 that is approximately equal to the outer diameter 114 of the canister 102. The nozzle opening 128 may have a different size and/or shape than the actuator opening 130 or have a similar size and/or shape.

The venturi system 122 also includes a manifold body 142 and a reservoir 144. The manifold body 142 has a first end 146 that is configured to be coupled in fluid communication with the canister 102 at the nipple 124. The first end 146 may also be supported by the cap 120. A second end 148 of the manifold body 142 is configured to support the venturi nozzle 134 and the nozzle cap 132. The venturi nozzle 134 has a first end 150 and an opposite second end 152. The second end 152 of the venturi nozzle 134 is received at least partially within the nozzle cap 132 and the first end 150 is coupled in fluid communication with the reservoir 144. A sealing member 154 (e.g., an O-ring) may be used with the venturi nozzle 134. The manifold body 142 can also include a plug 155 as required or desired.

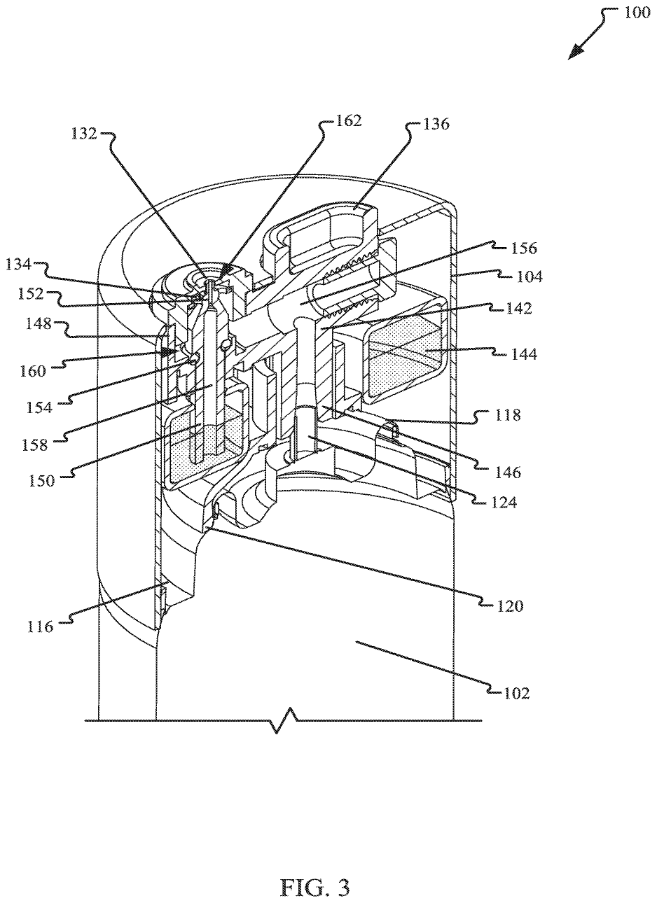

FIG. 3 is a cross-sectional, perspective view of the aerosol spray device 100. The canister 102 is configured to hold a propellant that is under pressure and the reservoir 144 is configured to hold an active solution. The propellant is contained separately and independently from the active solution within the aerosol spray device 100. The manifold body 142 defines a first flow path 156 for the propellant from the first end 146 towards the second end 148. In the example, the portion of the first flow path 156 at the first end 146 extends in a direction that is substantially parallel to the longitudinal axis 106 (shown in FIG. 1). Additionally, the portion of the first flow path 156 at the second end 148 extends in a direction that is substantially parallel to the longitudinal axis 106, but radially offset from the first end 146. As such, the first flow path 156 also has a transverse section that extends substantially orthogonal to the longitudinal axis.

In the example, the propellant within the canister 102 is prevented from flowing through the first flow path 156 and out the second end 148 until the user facilitates flow via the actuator 136. The actuator 136 may be a push button that releases propellant flow from the nipple 124 when actuated. In other examples, the actuator 136 may be any other type of release control/system that enables the aerosol spray device 100 to function as described herein. In an aspect, the actuator 136 releasing propellant flow through the first flow path 156 may be non-reversable such that propellant flow only ceases when the propellant is fully expelled from the canister 102. In other aspects, the actuator 136 may be configured to selectively open and close the first flow path 156 as required or desired. As illustrated, the actuator 136 is supported on the top of the manifold body 142, however, it is appreciated that the actuator 136 can be positioned at any other location relative to the manifold body 142 and on the cover 104.

The venturi nozzle 134 defines a second flow path 158 from the first end 150 toward the second end 152. In the example, the entirety of the second flow path 158 extends in a direction that is substantially parallel to the longitudinal axis 106. The first end 150 of the venturi nozzle 134 extends into the reservoir 144 and is in fluid communication therewith. The second end 152 of the venturi nozzle 134 is supported at least partially within the second end 148 of the manifold body 142 and within the first flow path 156. The first flow path 156 at the second end 148 of the manifold body 142 is concentric relative to the second flow path 158. The second flow path 158 proximate the second end 152 of the venturi nozzle 134 has a constricted diameter relative to the second flow path 158 proximate the first end 150 of the venturi nozzle 134.

The nozzle cap 132 partially covers the second end 148 of the manifold body 142 to define an outlet chamber 160 of the first flow path 156. The outlet chamber 160 receives the second end 152 of the venturi nozzle 134 such that the propellant can flow completely around the exterior of the venturi nozzle 134 before being discharged from the nozzle cap 132. The sealing member 154 provides a seal for the outlet chamber 160 relative to the venturi nozzle 134. The nozzle cap 132 defines an orifice 162 that defines the outlet of the first flow path 156. The orifice 162 is also shaped and sized such that the second end 152 of the venturi nozzle 134 at least partially is received and extends therethrough. The second end 152 of the venturi nozzle 134 defines the outlet of the second flow path 158. In the example, the first flow path 156 is completely independent from the second flow path 158 within the aerosol spray device 100. As such, the propellant from the first flow path 156 and the active solution from the second flow path 158 atomize at and project from the exterior of the nozzle cap 132. In other examples, the nozzle cap 132 may provide an inner chamber that enables the first flow path 156 and the second flow path 158 to mix prior to being discharged from the aerosol spray device 100.

In examples, the actuator 136 may be configured to at least partially open the second flow path 158 simultaneously with the first flow path 156. In other examples, the nozzle cap 132 may have a disposable seal for the user to remove and that opens the second flow path 258.

Further illustrated in FIG. 3, the cap 120 is coupled to the inner flange 118 of the canister 102. In an aspect, the cap 120 may be press-fit, snap-fit, or the like on the inner flange 118. The cap 120 is configured to support the manifold body 142 and the reservoir 144 so that the venturi system 122 (shown in FIG. 2) is at least partially disposed within the cover 104. In an aspect, the cover 104 may be coupled to the outer flange 116 of the canister 102. In other aspects, the cover 104 may be coupled to the canister 102 through the venturi system 122 components and the cap 120. In the example, the canister 102 is not configured to be replaceable/refillable for the venturi system 122 and the aerosol spray device 100 is a one-time use product. In other examples, the canister 102 and the reservoir 144 may be configured for replacement/refill as required or desired.

During operation, the user actuates propellant flow through the first flow path 156 via the actuator 136. The second flow path 158 is also opened. The actuator 136 may lock into an open flow configuration such that the propellant is continuously channeled towards the second end 148 of the manifold body 142 and at least partially around the exterior of the second end of the venturi nozzle 134 until the propellant charge is exhausted. When the propellant is expelled from the orifice 162 of the nozzle cap 132, the propellant siphons the active solution through the second flow path 158 and out of the second end 152 of the venturi nozzle 134. On discharge of the propellant and the active solution from the aerosol spray device 100, the propellant atomizes the active solution and projects the active solution for dispersion from the aerosol spray device 100. In an aspect, dispersion of the active solution from the aerosol spray device 100 occurs until the propellant is emptied from the canister 102 and the active solution is emptied from the reservoir 144. Based on the atomization (e.g., particle size) and the projection (e.g., velocity) of the active solution, the dispersion area of the aerosol spray device 100 can be defined.

In the example, the reservoir 144 is disposed above the canister 102 and the second flow path 158 has a shorter length than the first flow path 156. This configuration enables for the distance the active solution travels to be reduced and facilitates the siphoning via the flow of the propellant. In an aspect, the first flow path 156 is at least twice the length of the second flow path 158.

The venturi system 122 that enables the atomization and projection of the active solution is configured to facilitate a required or desired particle size and velocity of the active solution to define the dispersion area. In the example, the active solution may include at least one active that is an insecticide, herbicide, air sanitizer, surface sanitizer, fragrance, essential oil, anti-odorant, pharmaceutical, etc. In a specific example, the at least one active is an insecticide. In an aspect, the active may be mixed with at least one solvent. As such, the active solution may include at least one active and at least one solvent. In the example, the active solution is configured to be atomized to a particle size of about 5 to about 100 microns, about 10 to about 75 microns, about 10 to about 50 microns, or about 10 to about 30 microns. In an aspect, the active solution is configured to be atomized to a particle size of around 20 microns. Examples of the formula(s) of the active solution are described in U.S. Provisional Patent Application Ser. No. 63/517,401 titled INSECTICIDE COMPOSITION FOR USE IN A DIFFUSION APPLICATION (Attorney Docket No. 18457.0109USP1) and filed Aug. 3, 2023, and that is incorporated by reference herein in its entirety.

In the example, the reservoir 144 defines an interior volume that is configured to hold the active solution. The active solution may include from 0.5 grams to about 20 grams, about 1 gram to about 10 grams, or about 2 grams to about 7 grams of the at least one active. In an aspect, the active solution may include about 6 grams of the at least one active. The active solution may be in liquid form at least in part because of the at least one solvent.

The canister 102 is configured to hold a charge of propellant configured to atomize and propel the active solution and as described herein. The propellant may be pressurized within the canister 102 so that when the first flow path 156 is actuated the propellant may automatically flow therethrough because of the pressurization. In an aspect, the propellant has a pressure between 40 and 85 pounds per square inch within the canister 102. The pressure of the propellant may change based on the type of propellant used. In the example, the canister 102 may hold from about 0.25 ounces to about 10 ounces, from about 1 ounce to about 8 ounces, from about 0.25 ounces to about 6 ounces, or from about 2 ounces to about 3.5 ounces of the propellant. In an aspect, the canister 102 holds 3.5 ounces of the propellant. A volume of the canister 102 is greater than a volume of the reservoir 144, and as such, the aerosol spray device 100 includes a greater amount of propellant than active solution.

Exemplary propellant may include one or more of compressed air, hydrocarbons (e.g., A-85 hydrocarbon), hydrofluoroolefins (e.g., 1234ze), organofluorines (e.g., 152a -difluoroethane), and the like. The propellant preferably is considered to be “low VOC” or contains less than 100 grams/liter, less than 50 grams/liter, or less than 10 grams/liter of volatile organic compounds. In some examples, the propellant does not include any volatile organic compounds. Additionally or alternatively, the propellant is non-flammable.

In other examples, the canister 102 and the reservoir 144 may both include an active. In still other examples, neither the canister 102 nor the reservoir 144 may include an active. In still other examples, the canister 102 may include an active, while the reservoir 144 does not include an active.

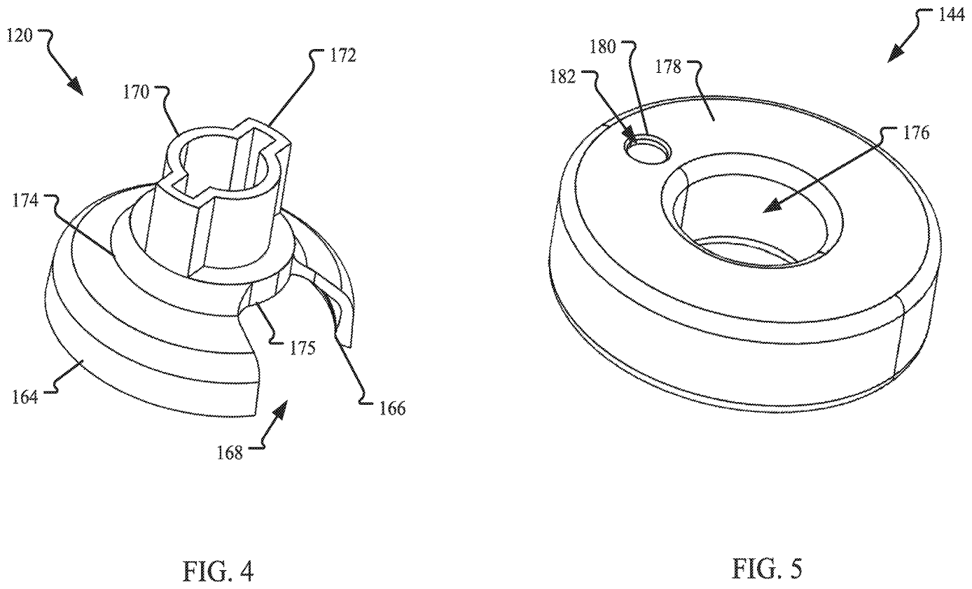

FIG. 4 is a perspective view of the cap 120 of the aerosol spray device 100 (shown in FIG. 1). The cap 120 has a body that includes a bottom end 164 having a radially inner lip 166 configured to couple to the inner flange 118 of the canister 102 (shown in FIG. 2). A notch 168 is defined at least partially in the bottom end 164. The body of the cap 120 also has a top end 170 defining a collar 172. The collar 172 is shaped and sized to receive at least partially the first end 146 of the manifold body 142 (shown in FIG. 2) so that the manifold body 142 can couple in flow communication with the canister 102. In the example, the collar 172 includes a substantially circular section with a pair of radially extending wings. A transition section 174 is disposed between the bottom end 164 and a top end 170 and an internal shoulder 175 extends annularly at the transition section 174.

FIG. 5 is a perspective view of the reservoir 144 of the aerosol spray device 100 (shown in FIG. 1). The reservoir 144 has a body that is substantially cylindrical in shape with an inner hole 176 extending therethrough that is open. A top wall 178 of the body defines an opening 180 so that the first end 150 of the venturi nozzle 134 (shown in FIG. 2) can extend within an inner chamber 182 of the reservoir 144 with a friction fit. The inner chamber 182 is configured to hold the active solution as described above. In an aspect, the reservoir 144 and the inner chamber 182 extends annularly around the longitudinal axis 106 (shown in FIG. 1). The inner hole 176 is configured to receive the collar 172 of the cap 120 (shown in FIG. 4) so that the reservoir 144 can be supported on the cap 120 (e.g., at least partially on the transition section 174 of the cap 120). In an example, the inner diameter of the inner hole 176 corresponds to the outer diameter of the wings of the collar 172 of the cap 120 for supporting the reservoir 144 on the cap 120. Alternatively, the reservoir 144 may have a body that is configured to be blow molded in construction. In this example, the reservoir 144 may not extend annularly around the longitudinal axis and may be positioned on one side of the collar 172.

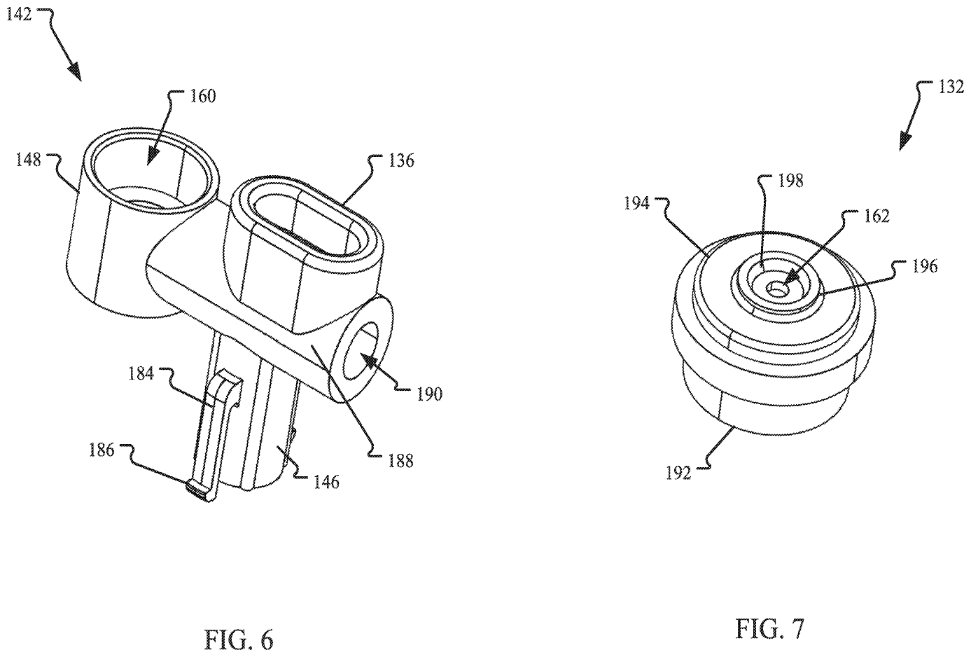

FIG. 6 is a perspective view of the manifold body 142 of the aerosol spray device 100 (shown in FIG. 1). The manifold body 142 defines the first flow path 156 (shown in FIG. 3) that extends from the first end 146 through to the second end 148. The first end 146 is configured to couple to the nipple 124 of the canister 102 (shown in FIG. 2). The first end 146 is formed as an elongate shaft that at least partially is inserted into the collar 172 of the cap 120 (shown in FIG. 4) for support. The first end 146 includes one or more clip arms 184. The clip arms 184 have a resilient free end spaced apart from the elongate shaft with a hook 186. The hook 186 of the clip arms 184 are configured to engage with the internal shoulder 175 of the cap 120 (shown in FIG. 4) to engage the manifold body 142 with the cap 120. The clip arms 184 may be received within the wings of the collar 172 so that rotation of the manifold body 142 relative to the cap 120 is restricted.

The second end 148 is offset from the first end 146 of the manifold body 142. The second end 148 defines the outlet chamber 160 that is substantially cylindrical in shape and that at least partially receives the venturi nozzle 134 (shown in FIG. 2). The nozzle cap 132 (shown in FIG. 2) may also be coupled to the second end 148 of the manifold body 142 and at least partially cover the outlet chamber 160. A transverse body section 188 is disposed between the first end 146 and the second end 148. The transverse body section 188 may have an opening 190 that is configured to receive the plug 155 (shown in FIG. 2) and define the first flow path 156. The actuator 136 may be supported on the transverse body section 188. In the example, the actuator 136 is configured to selectively lock down the nipple 124 (shown in FIG. 2) and actuate propellant flow through the first flow path 156 as described herein. In other examples, the actuator 136 may selectively open the first flow path 156, the second flow path 158, or both flow paths 156, 158. In yet other examples, the actuator 136 may have a mechanical delay so that propellant flow occurs a predetermined time after actuation.

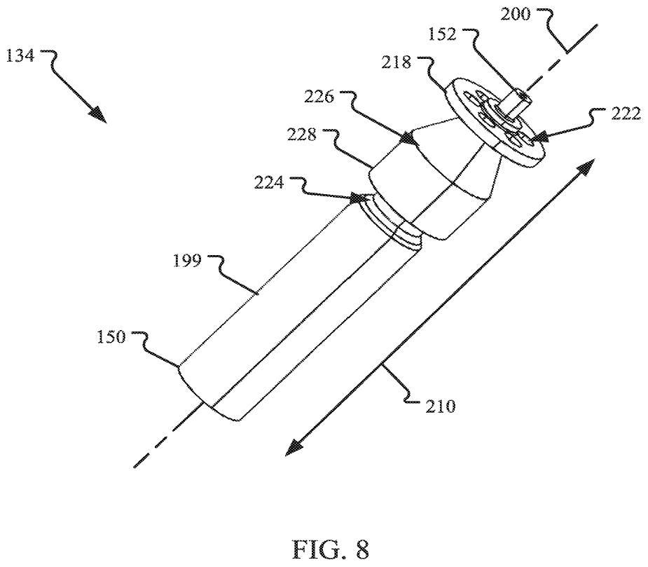

FIG. 7 is a perspective view of the nozzle cap 132 of the aerosol spray device 100 (shown in FIG. 1). The nozzle cap 132 has a body with a bottom end 192 that is configured to couple to the second end 148 of the manifold body 142 (shown in FIG. 6). A top end 194 of the body defines the orifice 162 that allows both the propellant and the active solution to be expelled from the aerosol spray device 100. The orifice 162 has a diameter that allows the second end 152 of the venturi nozzle 134 (shown in FIG. 2) to extend therethrough with additional space between the nozzle cap 132 and the venturi nozzle 134 so that propellant is expelled through the orifice 162. An annular flange 196 extends from the top end 194 and surrounds the orifice 162. The annular flange 196 is radially larger than the orifice 162 and includes an inner oblique surface 198. The annular flange 196 extends a height from the top end 194 so that the second end 152 of the venturi nozzle 134 does not project further out from the nozzle cap 132 than the annular flange 196.

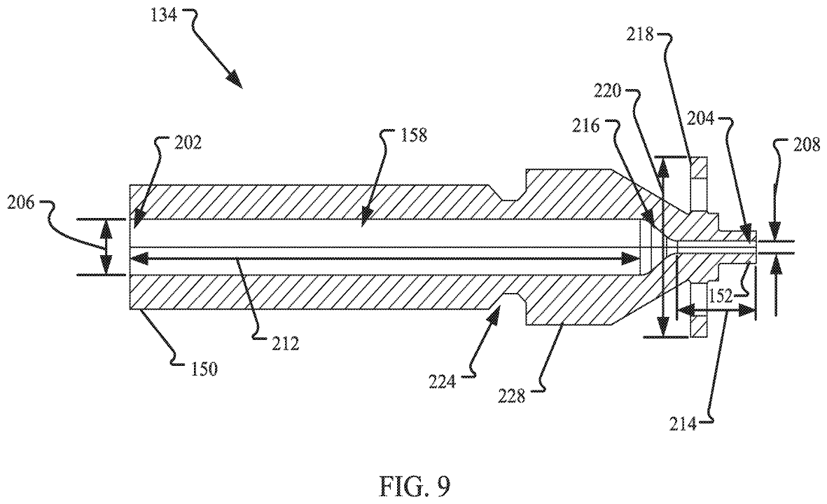

FIG. 8 is a perspective view of the venturi nozzle 134 of the aerosol spray device 100 (shown in FIG. 1). FIG. 9 is a cross sectional view of the venturi nozzle 134. The venturi nozzle 134 has a body 199 that forms the first end 150 and the second end 152. The first end 150 and the second end 152 define a longitudinal axis 200. An inlet orifice 202 is defined at the first end 150 and an outlet orifice 204 is defined at the second end 152. The second flow path 158 is defined between the inlet orifice 202 and the outlet orifice 204 extending along the longitudinal axis 200. The inlet orifice 202 has an inlet diameter 206 that is larger than an outlet diameter 208 of the outlet orifice 204. The first end 150 and the second end 152 also define a longitudinal length 210. The geometry of the venturi nozzle 134 facilitates the propellant being capable of siphoning the active solution through the second flow path 158 and atomization of the active solution while being projected from the aerosol spray device 100.

In an aspect, the outlet diameter 208 is 20-30% of the size of the inlet diameter 206. In another aspect, the outlet diameter 208 is about 22% of the size of the inlet diameter. The inlet diameter 206 extends from the first end 150 towards the second end 152 a first length 212, while the outlet diameter 208 extends from the second end 152 towards the first end 150 a second length 214. The first length 212 being longer than the second length 214. In an aspect, the second length 214 is 10-20% of the longitudinal length 210 of the body 199. In another aspect, the second length 214 is about 13% of the longitudinal length 210 of the body 199. The second flow path 158 includes a transition section 216 whereby the inlet diameter 206 tapers radially inwardly to the outlet diameter 208. The transition section 216 is located closer to the outlet orifice 204 than the inlet orifice 202.

Proximate the second end, an annular flange 218 is integral with the body 199 and extends radially from the longitudinal axis 200. The annular flange 218 has an outer diameter 220 that is larger than any outer diameter of the body 199. A plurality of apertures 222 are defined within the annular flange 218 and circumferentially spaced around the longitudinal axis 200. In the example, there are six apertures 222 that are similarly shaped and sized. In other aspects, greater than or less than 6 apertures 222 are also contemplated herein, as well as apertures having different shapes and sizes. The top of the annular flange 218 is configured to be positioned directly against the nozzle cap 132 (shown in FIG. 9) such that the first flow path 156 (shown in FIG. 3) is through the apertures 222. Each aperture 222 has a diameter is that is larger than the outlet diameter 208 and smaller than the inlet diameter 206. The annular flange 218 is longitudinally offset from the outlet orifice 204 so that a portion of the second end 152 can extend through the nozzle cap 132.

Between the first end 150 and the second end 152, the body 199 includes an exterior annular groove 224 that is shaped and sized to receive the sealing member 154 (shown in FIG. 2). The sealing member 154 engages with the manifold body 142 at the second end 148 to seal the outlet chamber 160 (all shown in FIG. 6). As such, an exterior surface 226 of the body 199 between the annular groove 224 and second end 152 is configured for the propellant to flow around and is positioned within the first flow path 156. The body 199 includes a radial shoulder 228 adjacent to the annular groove 224 and forming the exterior surface 226. The radial shoulder 228 tapers radially inward as the shoulder 228 extends towards the annular flange 218. In an aspect, the outer diameter of the radial shoulder 228 is larger than the outer radial extent of the apertures 222. The geometry of the exterior surface 226 and the annular flange 218 at least partially form the first flow path 156, and thus, facilitate the function of the propellant as described herein.

In the example, the venturi nozzle 134 including the body 199 and the integrally formed flange 218 are formed from a plastic based material. By forming the venturi nozzle 134 out of plastic, manufacturing efficiencies are increased and material costs are lowered. In an example, the venturi nozzle 134 may be injection molded, blow molded, or the like. In an aspect, the venturi nozzle 134 is formed from polypropylene, polyethylene, or the like.

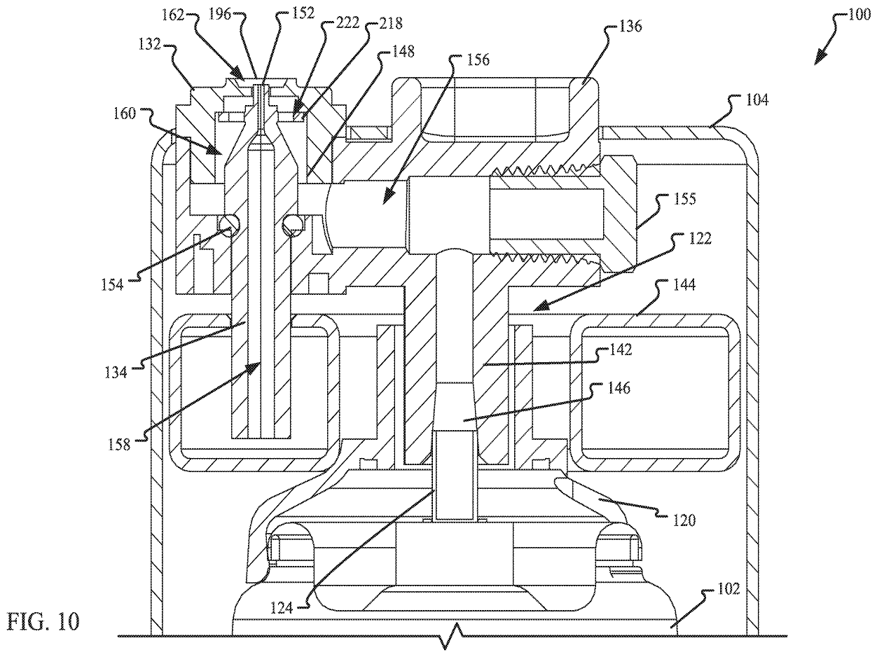

FIG. 10 is a partial cross-sectional view of the aerosol spray device 100. Certain components are described above, and thus, are not necessarily described further. The first flow path 156 enables the propellant to be channeled through the venturi system 122 and emitted from the nozzle cap 132. The geometry of the first flow path 156 at least partially facilitates the flow characteristics of the propellant and how the active solution is siphoned from the reservoir 144 and through the second flow path 158. Additionally, the flow path geometry at least partially facilitates the flow characteristic of the propellant and how the active solution is atomized and projected at the nozzle cap 132. For example, the second end 148 of the manifold body 142 forms the outlet chamber 160 which enables the first flow path 156 to surround the venturi nozzle 134 and be discharged from the nozzle cap 132 through the apertures 222 of the annular flange 218. The propellant is discharged through the outlet orifice 162 of the nozzle cap 132 without mixing with the second flow path 158. In the example, the annular flange 218 of the venturi nozzle 134 is positioned against the inside of the nozzle cap 132 to force the first flow path 156 through the apertures 222.

The second flow path 158 enables the active solution to be channeled through the venturi nozzle 134 and emitted from the second end 152 via the propellant. The geometry of the second flow path 158 at least partially facilitates the flow characteristics of the active solution and atomization thereof. For example, the second end 152 extends through the outlet orifice 162 of the nozzle cap 132 with space for the propellent to exit from the outlet orifice 162 and surround the second end 152. The second end 152 also terminates below the flange 196 at the top of the nozzle cap 132. The actuator 136 is disposed remote from the nozzle cap 132 to facilitate ease of use.

In operation, the nozzle cap 132 is configured to disperse the atomized active solution in a full 360° area that surrounds the aerosol spray device 100. In other examples, the nozzle cap 132 and/or the second end 152 of the venturi nozzle 134 may be angled to concentrate the dispersion to a predetermined area, for example, in a 270° area, a 180° area, a 90° area or the like and configured for use against a wall or a corner of an interior room. In still other aspects, more than one nozzle may be incorporated within the aerosol spray device, or a spinner nozzle may be used. In examples, the nozzle cap 132 is configured to expel (e.g., form a plume) the atomized active solution 6 feet, 8 feet, 10 feet, or more into the air. As such, efficacy of the atomized active solution is enabled for 1,000 cubic feet-2,000 cubic feet areas. In examples, efficacy is enabled for areas greater than 2,000 cubic feet.

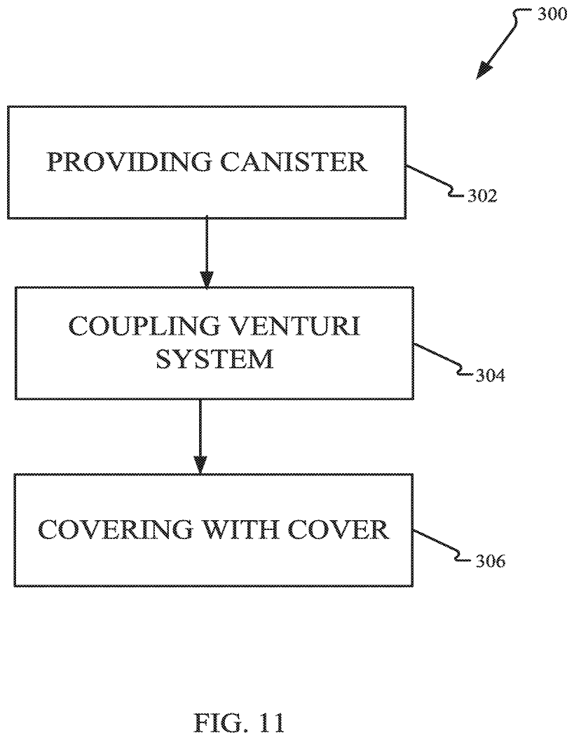

FIG. 11 illustrates a flowchart depicting a method 300 of assembling an aerosol spray device. The example methods and operations can be implemented or performed by the assemblies described herein (e.g., the aerosol spray device 100 shown in FIGS. 1-10). The method begins with providing a canister holding a propellant under pressure (operation 302). A venturi system is coupled to the canister (operation 304). The venturi system includes a manifold body having a first end and a second end defining a first flow path. The first end of the manifold body is coupled in fluid communication to the canister. The venturi system further includes a reservoir holding an active solution discrete from the reservoir. A venturi nozzle having a first end and a second end defining a second flow path, the first end of the venturi nozzle coupled in fluid communication with the reservoir and the second end of the venturi nozzle supported at least partially within the second end of the manifold body and within the first flow path. The second flow path is proximate the second end of the venturi nozzle having a constricted diameter relative to the second flow path proximate the first end of the venturi nozzle. The venturi system also includes an actuator configured to selectively actuate flow of the propellant through the first flow path. The venturi system is then at least partially covered on the canister with a cover (operation 306). The second end of the venturi nozzle and the actuator at least partially extending from the cover, the actuator positioned remote from the venturi nozzle.

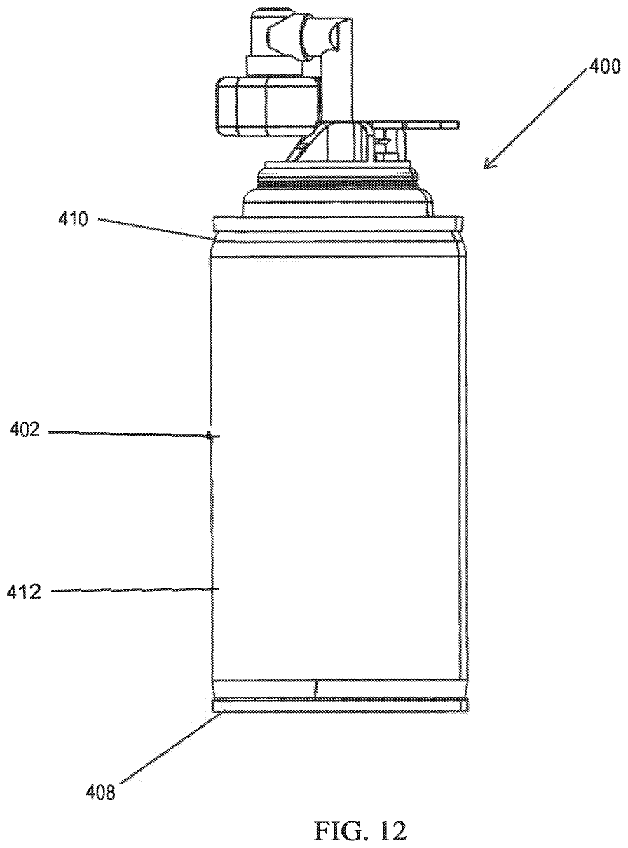

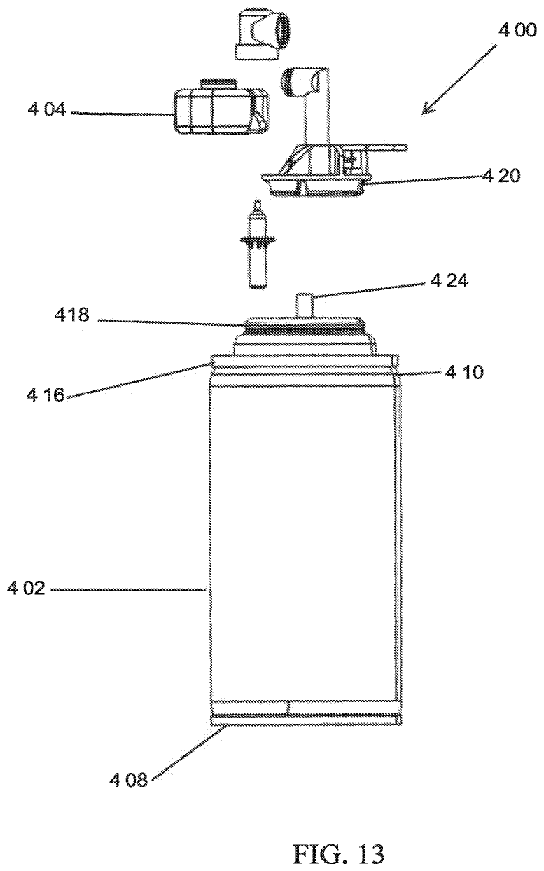

FIG. 12 is a perspective view of a second embodiment of an aerosol spray device 400. FIG. 13 is an exploded, perspective view of the aerosol spray device 200. Referring concurrently to FIGS. 12 and 13, the aerosol spray device 400 may be similar to the device described above and includes a canister 402 and a cover (not shown) configured to couple together along a longitudinal axis. The canister 402 is substantially cylindrical in shape with a bottom end 408 and a top end 410 disposed along the longitudinal axis. A cylindrical side wall extends between the bottom and top ends 408, 410, and has an outer diameter. The bottom end 408 is configured to be placed on an underlying surface (not shown) and allow the aerosol spray device 400 to stand upright on its own and not tip over.

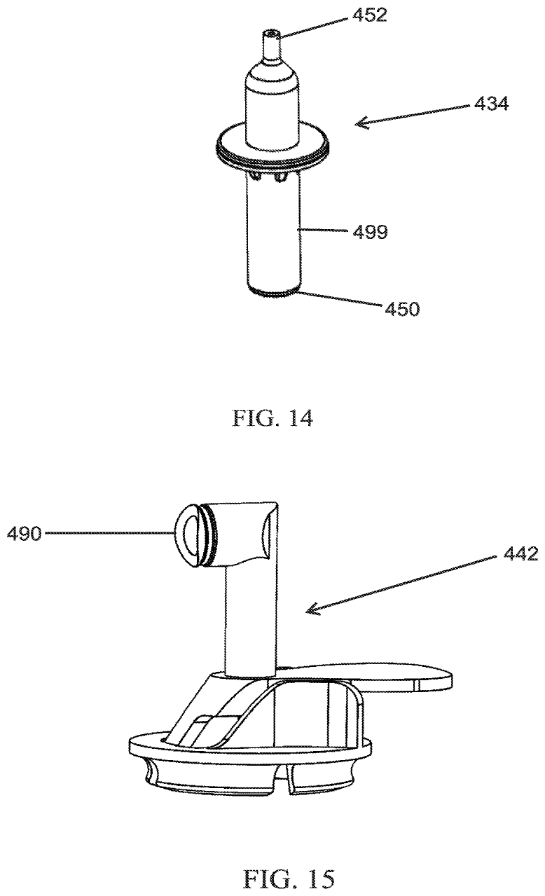

FIG. 14 is a perspective view of the venturi nozzle 434 of the aerosol spray device 400 (shown in FIG. 12). The venturi nozzle 434 has a body 499 that forms the first end 450 and the second end 452. The geometry of the venturi nozzle 434 facilitates the propellant being capable of siphoning the active solution through a second flow path and atomization of the active solution while being projected from the aerosol spray device 400 as described above. However, the venturi nozzle 234 may have a different shape and/or size.

In an aspect, an outlet diameter of the second end 252 is 20-30% smaller than the size of an inlet diameter of the first end 250. In another aspect, the outlet diameter is about 22% smaller than the size of the inlet diameter. The inlet diameter extends from the first end 450 towards the second end 452 along a first longitudinal length, while the outlet diameter extends from the second end 452 towards the first end 450 a second longitudinal length. The first length being longer than the second length. In an aspect, the second length is between 10-20% of the total longitudinal length of the body 499 between the first end 450 and the second end 452. In another aspect, the second length is about 13% of the longitudinal length of the body 499.

In the example, the venturi nozzle 434 including the body 499 and an integrally formed flange are formed from a plastic based material. In this example, the flange may not define any apertures and instead be utilized for at least partially defining the first flow path for the canister. By forming the venturi nozzle 434 out of plastic, manufacturing efficiencies are increased and material costs are lowered. In an example, the venturi nozzle 434 may be injection molded, blow molded, or the like. In an aspect, the venturi nozzle 434 is formed from polypropylene, polyethylene, or the like.

FIG. 15 is a perspective view of the manifold body 442 of the aerosol spray device 400 (shown in FIG. 12). The manifold body 442 defines the first flow path that extends from a first end through to a second end. The second end is offset from the first end of the manifold body 442. The second end defines an outlet chamber that is substantially cylindrical in shape and that at least partially receives the venturi nozzle (shown in FIG. 14).

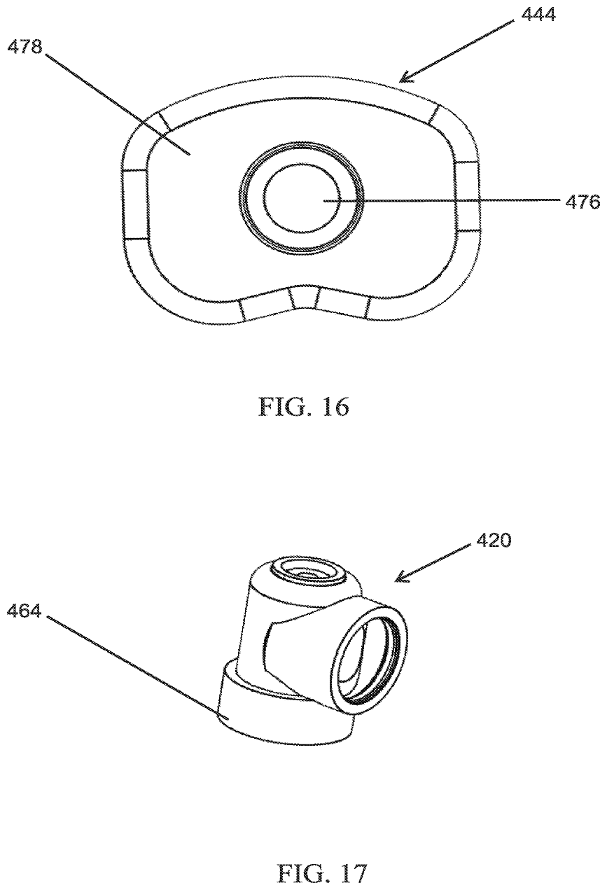

FIG. 16 is a perspective view of the reservoir 444 of the aerosol spray device 400 (shown in FIG. 12). The reservoir 444 has a body that is configured to be disposed on top of the canister. A top wall 478 of the body defines an opening 476 so that the first end of the venturi nozzle 434 (shown in FIG. 14) can extend within an inner chamber of the reservoir 444 with a friction fit. The inner chamber is configured to hold the active solution as described herein. In an aspect, the top wall 478 of the reservoir 444 extends substantially annularly around the venturi nozzle 434. The inner hole 476 is configured to receive a collar 464 of a cap 420 (shown in FIG. 17) so that the reservoir 444 can be supported on the cap 420 (e.g., at least partially on the transition section of the cap 420). This connection between the cap and the reservoir may also receive the flange of the venturi nozzle for supporting the venturi nozzle therein. In an example, the inner diameter of the inner hole 476 corresponds to the outer diameter of the collar of the cap 420 for supporting the reservoir 444 on the cap 420. Alternatively, the reservoir 444 may have a body that is configured to be blow molded in construction. In this example, the reservoir 444 may not extend annularly around the longitudinal axis and may be positioned on one side of the collar. The cap 420 is also configured to couple in flow communication with the top end of the manifold body 442.

FIG. 17 is a perspective view of the cap 420 of the aerosol spray device 400 (shown in FIG. 12). The cap 420 has a body that includes a bottom end 264 having a radial inner lip configured to couple to the reservoir as described above (shown in FIG. 13).

According to the second embodiment of the aerosol spray device 400, the insecticide or chemical component may be located in the reservoir 444, off to the side of the canister 402 of the aerosol spray device 400. Through a rocking motion, the aerosol spray device 400 dispenses an active chemical component or insecticide through the venturi nozzle 434.

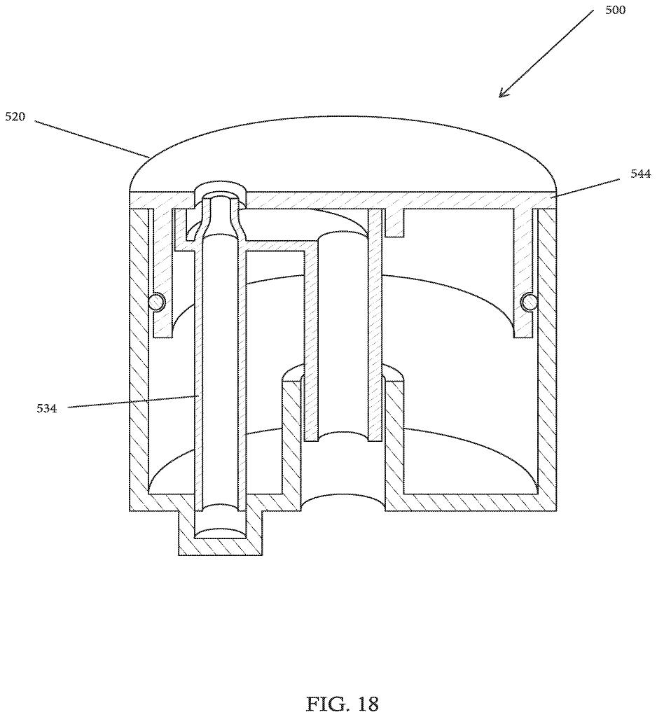

FIG. 18 illustrates another example of the present disclosure, where the aerosol spray device 500 may include the cap 520, reservoir 544, and venturi nozzle system 534. This embodiment may only require the three components in order to simplify assembly and use. The cap 520 of the aerosol spray device 500 is locked into place to activate the system. The cap 520 is placed on a first, top surface of the reservoir 544 holding the active and an O-ring is used to seal the cap and the reservoir. The venturi nozzle system 534 extends into the reservoir 544, from the first, top surface of the reservoir 544. A venturi stem extends vertically along a central axis of the reservoir 544, and routes propellant and active towards the cap 530. A sonic weld is used to connect the cap 530 and the stem of the venturi nozzle 534, with an outer portion that allows for propellant exhaust, and an inner portion of the stem that allows for active exhaust.

In one embodiment, the O-rings discussed above may be used to create a seal between each of the components (cap 520, reservoir 544, and venturi system 534). In another embodiment, a plastic rip component may be used to seal each of the pieces, rather than the O-rings, to reduce assembly and create a 3-piece design without added sealing components.

The aerosol spray device may include hooks on the bottom of the reservoir 544 that allow the system to be attached to the top of an aerosol can.

In use, the aerosol spray device that is consolidated to three pieces functions using two separate flow paths on the venturi nozzle system 534. When engaged for use, the cap 520 is locked on to each side of the reservoir 544 to maintain activation. The system is sealed both internally, and externally using either O-rings or a plastic rib feature.

The aerosol spray device described herein facilitates control of the atomization and projection of the active solution upon discharge. The venturi system includes a manifold body that defines a first flow path for a propellant contained within a canister. Additionally, the venturi system includes a venturi nozzle that defines a second flow path for the active solution contained within a reservoir and separate from the propellant in the canister. An actuator is provided so that upon activation, the first flow path is opened such that the propellant continuously flows from the canister through the venturi system. The flow of propellant siphons the active solution through the second flow path and atomizes and projects the active solution for dispersion. The configuration of the venturi system enables the atomization (e.g., particle size) and projection (e.g., velocity) of the active solution to be better controlled and for a dispersion area to be better defined. Too large of particle size, the distribution area of the active solution is too small and the active solution pools around the aerosol spray device, while too small of particle size may increases inhalation concerns. Furthermore, the actuator is positioned remote from the outlet orifices of the propellant and the active solution, thereby providing an improved user interface.

The venturi system including the manifold body, the reservoir, the venturi nozzle, and the actuator have a compact size so that it can fit within a cover and disposed on top of the canister. The venturi nozzle is formed from a plastic material that decreases manufacturing costs while increasing aerosol spray device performance for dispersion area saturation and efficacy.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

The present disclosure also relates to an insecticide composition, and methods of use with the venturi system disclosed herein. In some embodiments, the composition comprises a knockdown agent, a killing agent, a solvent, a synergist, and combinations thereof. In some embodiments, the insecticide composition comprises a synthetic pyrethroid, a synergist, and a solvent system. In some embodiments the insecticide is dispelled through the venturi system using a propellant.

In one embodiment, the propellant may include hydrocarbon propellants (any combination of N-butane/isobutane/propane). In one embodiment, the propellant may be 1,1-Difluoroethane (152a) or Trans-1,3,3,3-Tetrafluoroprop-1-ene (Solstice 1234 ze). In some embodiments, the propellant is selected from the group consisting of air, argon, butane, carbon dioxide, a chlorofluorocarbon, dimethyl ether, a hydrofluorocarbon, nitrogen, and a mixture thereof. In some embodiments, the insecticide composition is preferably free of any propellant.

### Insecticide Composition

The composition may include a killing agent. Exemplary killing agents include carbamates, organophosphates, pyrethrins/pyrethroids, and neonicotinoids. The killing agent may be present in the insecticide composition in a concentration of about 0.1 to about 20 wt. %, about 0.5 to about 15 wt. %, or about 1 to about 10 wt. %.

In some embodiments, the carbamates may include ethienocarb, sevin, carbaryl, fenoxycarb, furadan, carbofuran, aldicarb, 2-(1-Methylpropyl) phenyl N-methylcarbamate, and combinations thereof.

In some embodiments, the organophosphates may include malathion, parathion, diazinon, fenthion, dichlorvos, chlorpyrifos, ethion and combinations thereof.

In some embodiments, the neonicotinoids may include midacloprid, acetamiprid, dinotefuran, thiamethoxam, clothianidin, and combinations thereof.

In some embodiments, the composition includes a killing agent that is at least one synthetic pyrethroid. Synthetic pyrethroids are insecticides with similarities to natural pyrethrins. Pyrethroids work by disrupting an insect's nervous system causing a weakened state, which is followed by death. Examples of suitable pyrethroids include bifenthrin, permethrin, phenothrin, cypermethrin, cyfluthrin, deltamethrin, fenvalerate, and lambda cyhalothrin. Additional synthetic and natural pyrethroids may include but not be limited to permethrin, deltamethrin, bifenthrin, fluvalinate, fenvalerate, esfenvalerate, lambda cyhalothrin, tetramethrin, cyfluthrin, resmethrin, allethrin, bioallethrin, esbiothrin, s-bioallethrin (ESBIOL®), d-allethrin; cypermethrin; zeta cypermethrin, tau fluvalinate, channel blocking insecticide, acetylcholinesterase inhibitor, oxadiazines; organophosphate, chlorpyriphos, acephate, neonicotinoid insecticide, thiamethoxam, imidacloprid, acetamiprid, thiacloprid, clothianidin, nitenpyram, insect growth regulator, teflubenzuron, flufenoxuron, bistrifluoron, hexaflumuron; juvenile hormone mimic such as pyriproxyfen, methoprene and fenoxycarb, fermentation insecticide such as abamectin, spiromesifen, spinosad, and Bacillus thuringiensis, plant oil insecticide such as cinnamon, rosemary, wintergreen, citrus and clove oils, acaricide, miticide, fungicide, herbicide and combinations thereof. In a preferred embodiment, the pyrethroid is phenothrin, having the structure:

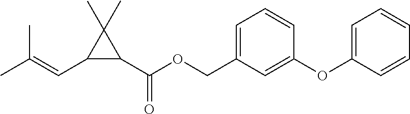 [SMILES: CC(C)=CC1C(C(=O)OCc2cccc(Oc3ccccc3)c2)C1(C)C]

An exemplary phenothrin is sold under the name SUMITHRIN. The pyrethroid may be present in the insecticide composition in a concentration of about 0.1 to about 20 wt. %, about 0.5 to about 15 wt. %, or about 1 to about 10 wt. %.

The composition may also include a synergist. Exemplary synergists include piperonyl butoxide (PBO), N-octylbicycloheptenedicarboximide, propargyl propyl phenylphosphonate, and combinations thereof. A preferred synergist is piperonyl butoxide (PBO):

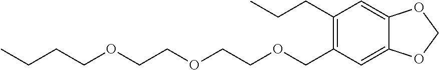 [SMILES: CCCCOCCOCCOCc1cc2c(cc1CCC)OCO2]

The synergist enhances the kill activity of the synthetic pyrethroid against insects. The synergist may be present in the insecticide composition in an amount from about 0.1 wt. % to about 10 wt. %, about 0.5 wt. % to about 5 wt. % or about 1 wt. % to about 5 wt. %. In some embodiments, the synergist is optional and the composition is free or substantially free of a synergist.

While not wanting to be bound by theory, it is believed that pyrethroids are lethal against insects by preventing the closure of the voltage-gated sodium channels in the axonal membranes. When the toxin produced by pyrethroids keeps the sodium channels in their open state, the nerves cannot repolarize, leaving the axonal membrane permanently depolarized, which may result in permanent paralysis of the organism. Insects contain natural enzymes, such as microsomal P450 enzymes, that help metabolize pyrethroids. Synergists, such as piperonyl butoxide, inhibit the insect's naturally occurring enzymes such as microsomal P450 enzymes and increase the lethality of the pyrethroid.

The composition may include one or more solvents. Exemplary solvents include water, hydrocarbons, isoparaffinic hydrocarbon, aromatic hydrocarbons, chlorinated aromatic hydrocarbons, mineral oil, mineral spirits, alkylbenzene, C1-C10 alcohols, isopropyl alcohol, propanol, ethanol, butanol, C1-C10 glycol ethers, C1-C10 glycol esters, C1-C10 ketones, dimethylformamide, dimethyl sulphoxide, spindle oil, naturally-derived oils such as vegetable oil, olive oil, coconut oil, soy oil, and derivatives and combinations thereof. The solvent may be present in the insecticide composition in concentration from about 50 wt % to about 99 wt %, about 75 wt. % to about 95 wt. %, about 85 wt. % to about 95 wt. %, about 50 to about 75 wt. %, or about 50 to about 60 wt. %. Preferably, the solvent may be present in the insecticide composition in a concentration from about 85 wt. % to about 94 wt. %.

In some embodiments, the insecticide composition optionally includes a knockdown agent. Exemplary knockdown agents include Tetramethrin, Imiprothrin (Pralle), Prallethrin (ETOC), Momfluorothrin (Sumifreeze) and derivatives and combinations thereof. “Knockdown,” as the term is used herein, is the characteristic of the pesticide whereby the pest, if a flying pest such as a common housefly, is knocked out of the air or, if a crawling pest such as a cockroach, is caused to lie dormant with low activity or mobility or moving in an inconsistent manner or giving the appearance of death to the insects, even if not dead. Rapid knockdown is desirable in such pesticides if the consumer equates the effectiveness of the pesticides with the falling out of the air of a flying pest, such as the common housefly, or with the paralyzing of a pest, if a crawling pest such as the common cockroach.

According to the Environmental Protection Agency (EPA) of the United States, to make “knockdown” or “quick kill” or “kills on contact” claims for pesticides, data should be provided that show (1) ≥90% knockdown within 10 seconds for stinging Hymenoptera (including fire ants) or within 30 seconds for all other arthropods; and (2) ≥90% mortality by 96 hours post-treatment.

In certain embodiments, the knockdown agent is selected from the group consisting of tetramethrin, imiprothrin, prallethrin (ETOC®), momfluorothrin (SUMIFREEZE®), and combinations thereof. In certain embodiments, the killing agent is cyhalothrin.

In some embodiments, the present composition may optionally include an additional synergist such as piperonyl butoxide, N-octylbicycloheptenedicarboximide, propargyl propyl phenylphosphonate and combinations thereof. The additional synergist may be present in the insecticide composition in an amount from about 0.1 wt. % to about 10 wt. %, about 0.5 wt. % to about 5 wt. % or about 1 wt. % to about 5 wt. %.

In embodiments, the present composition may optionally include an antioxidant such as ethoxyquin or tertiary butylhydroquinone (TBHQ), and an ultraviolet light absorber such as ethylhexyl methoxycinnamate or benzophenone, or other additives.

The disclosed composition may optionally include other additional functional ingredients selected from the group consisting of thickeners or rheology modifiers, surfactants, colorants, fragrances, insect attractants, insect bait, additional insecticides, propellant, and combinations thereof.

In some embodiments, the present composition optionally includes a thickener or rheology modifier. Exemplary thickeners include xanthan gum, carboxymethyl cellulose, alginates, carrageenan gum, locust bean gum, tragacanth gum, guar gum, polyacrylic acid derivatives, modified clays, finely divided silica, and derivatives and combinations thereof. In embodiments, the insecticide composition disclosed herein may have a viscosity of about 10 cps to about 200 cps, about 10 cps to about 100 cps, or about 100 cps to about 200 cps, when measured using a Brookfield viscometer with a spindle size of 62 at 60 rpm at room temperature (20° C.).

In some embodiments it is beneficial for the insecticide compositions to have a desired particle size when dispensed in a diffusion or aerosol application. The particle size is preferably in the range of about 5 microns to about 100 microns, about 10 microns to about 50 microns, or about 10 microns to about 20 microns. If the particle size is too small, it may be inhaled by people or domestic animals and cause sensitivities or health concerns. If the particle size is too large, the droplets will not become suspended in the air or will drop out shortly after being dispensed. This causes a puddle to form around the dispenser. It also means that the composition is not reaching locations in the room that are farthest from the dispenser. If a sufficient amount of the active is not reaching parts of the room, insects present in that location may survive that treatment and prolong the infestation. A thickener or rheology modifier may be beneficial for creating the desired particle size when the composition is dispensed as an aerosol. In some embodiments, the thickener is included in an amount sufficient to generate the desired viscosity or the desired particle size. In some embodiments, the thickener is included in an amount of from about 0.01 wt. % to about 8 wt. %, from about 0.1 wt. % to about 5 wt. %, from about 0.5 wt. % to about 3 wt. %, or from about 1 wt. % to about 2 wt. %.

In some embodiments, the insecticide composition optionally includes a surfactant. A surfactant is a surface-active agent, which refers to any compound that reduces surface tension when dissolved in water or water solutions, or that reduces interfacial tension between two liquids, or between a liquid and a solid. Examples of surfactants include, but are not limited to: (1) fatty acid esters such as glycerol esters, PEG esters, and sorbitan esters, including ethylene glycol distearate, ethylene glycol monostrearate, glycerol mono and/or dioleate, PEG dioleate, PEG monolaurate, sorbitan monolaurate, sorbitan trioleate; (2) nonionic ethoxylates such as alkylphenol ethoxylates, alcohol ethoxylates, alkylamine ethoxylates, such as octylphenol ethoxylate, nonylphenol ethoxylate, alkylamine ethoxylates; (3) nonionic surfactants such as 2,4, 7,9-tetramethyl-5-decyn-4,7-diol; and (4) ethylene oxide/propylene oxide copolymers.

In some embodiments, the surfactant is selected from among an anionic surfactant, a cationic, a nonionic surfactant, an amphoteric surfactant, and a combination thereof. In a particular example, the surfactant is an anionic surfactant that is selected from among fatty soaps, alkyl sulfates, sulfated oils, ether sulfates, sulfonates, sulfosuccinates, sulfonated amides and isethionates. In another example, the anionic surfactant is selected from among alkyl sulfonate surfactants, a linear alkylbenzene sulfonic acid, a branched alkylbenzene sulfonic acid a C12-C18 alkylsulfate, C12-C18 alkyl alkoxy sulfate, C12-C18 alkyl methyl ester sulfonate and combinations thereof. In a particular example, the surfactant is a cationic surfactant that is selected from among an alkylamine, an alkyl diamine, an alkyl polyamine, a mono- or di-quaternary ammonium salt, a monoalkoxylated amine, a dialkoxylated amine, a monoalkoxylated quaternary ammonium salt, a dialkoxylated quaternary ammonium salt, an etheramine, an amine oxide, an alkoxylated amine oxide and a fatty imidazoline and combinations thereof. In another particular example, the surfactant is a nonionic surfactant that is selected from among an alkoxylated alcohol, a dialkoxylated alcohol, an alkoxylated dialkylphenol, an alkylpolyglycoside, an alkoxylated alkylphenol, an alkoxylated glycol, an alkoxylated mercaptan, an alkylamine salt, an alkyl quaternary amine salt, a glyceryl or polyglyceryl ester of a natural fatty acid, an alkoxylated glycol ester, an alkoxylated fatty acid, an alkoxylated alkanolamide, a polyalkoxylated silicone and an N-alkyl pyrrolidone and combinations thereof.

In some embodiments, the insecticide composition optionally includes a colorant or other visual indicator. The colorant or visual indicator may be added to the insecticide compositions. The colorant can provide additional visual cues to the operator of where the composition has been applied or spread. Exemplary colorants for use in the provided compositions and formulations include, but are not limited to, dyes and pigments such as titanium oxide, titanium dioxide, zinc oxide, an azo-type colorant, a condensate-type colorant, a phthalocyanine-type colorant, a quinacridone-type colorant, an insoluble lake pigment, and organic dyes, such as alizarin dyes, azo dyes, or metal phthalocyanine dyes. The colorant or visual indicator may aid in providing visual confirmation that the composition is reaching the desired location.

The composition may include additional insecticide classes, such as carbamates, organophosphates, pyrethrins/pyrethroids, neonicotinoids, pyrroles, or combinations thereof.

In some embodiments, the insecticide composition optionally includes a fragrance or flavor substance or an agent impacting a pleasant odor. Non-limiting examples of fragrance agents or agents imparting a pleasant odor include fruit ester, damascenone, alpha-ionone, beta-ionone, raspberry ketone, furanone derivative, limonene, linalool, phenylacetaldehyde, 2-phenylethanol, maltol, vanillin, eugenol, anethol, anise alcohol, anisaldehyde, guajakol, cinnamyl alcohol, cinnamaldehyde, citral, citronellal, citronellol, nerol, geraniol, ethylvanillin, benzyl alcohol, anisaldehyde, cinnamyl ester, benzyl ester, damascene, diacetyl, dihydrocoumarin, beta-dihydroionone, dimethyl anthranilate, methyl anthranilate, ethylmalton, heliotropin, cis-3-hexenyl ester, ethyl decadienoate, methyl dihydrojasmorvate, methyl cinnamate, ethyl cinnamate, p-mentha-8-thiol-3-one, rose oxide, ketoisophorone, and combinations thereof in any proportions.

In some embodiments, the insecticide composition optionally includes an insect attractant. The attractant may be selected from the group consisting of pheromones, plant volatiles, flower oil, sugar, protein, or combinations thereof.

In some embodiments, the insecticide composition optionally includes an insect bait. The bait may include at least one active ingredient, such as an insecticide or the composition disclosed herein, and at least one food component configured to attract insects.

In some embodiments, the insecticide composition optionally includes a propellant. In one embodiment, the propellant may include hydrocarbon propellants (any combination of N-butane/isobutane/propane). In one embodiment, the propellant may be 1,1-Difluoroethane (152a) or Trans-1,3,3,3-Tetrafluoroprop-1-ene (Solstice 1234 ze). In some embodiments, the propellant is selected from the group consisting of air, argon, butane, carbon dioxide, a chlorofluorocarbon, dimethyl ether, a hydrofluorocarbon, nitrogen, and a mixture thereof. In some embodiments, the insecticide composition is preferably free of any propellant.

The concentration of the insecticide composition in air may vary based on the size of the room, the amount of the composition diffused, and whether the room or space is enclosed. The concentration in air may also be affected by the temperature, air currents, ventilation, humidity, time, and the size of the space. The concentration of the insecticide composition in air may decrease with duration. For example, the concentration of the composition when first diffused, will be higher than the concentration after time has passed. The in-air concentration may also depend on the type of pest being treated and the life-stages of the pest.

In embodiments, the insecticide composition may be a liquid, thickened liquid, oil, emulsion, oil in water emulsion, or gel product to be added to a diffuser, dispenser, or fogger. In another embodiment, the composition may be a powder, granule, or tablet that can be added to a liquid solvent to create a liquid.

After being diffused, the insecticide composition will be suspended in air. After an amount of time, the diffused insecticide may fall, or begin to fall towards the ground and land on or adhere to surfaces.

### Method of Using the Insecticide Composition

The composition disclosed herein may be used for the purpose of killing insects. The composition may be diffused, aerosolized, or fogged to aid in the termination of insects. When used in diffusion, aerosols, or fogging, the composition may be added in a liquid form, or another suitable form, to the device or system, to fill a space or room.

In embodiments, the diffusion, aerosol, or fogging of the composition disclosed herein may occur once, or any number of times required to eliminate an infestation or outbreak of pests or insects. Once added to a diffusion or dispensing device, the composition is distributed in a room or space. The composition may be effective against all life-stages of an insect, including eggs, thereby preventing the possibility of future infestation from the same grouping of insects.

In embodiments, the insecticide composition disclosed herein may be effective and used with both crawling and flying insects including but not limited to moths, fleas, ticks, ants, mosquitos, cockroaches, flies, and others. The insecticide composition is preferably effective against all life stages of an insect, including the egg, larvae, pupae, and adult stages in order to prevent future generations from surviving the treatment and propagate the infestation.

The insecticide composition disclosed herein may be used with a diffusion, aerosol, or fogging applicator. The aerosol spray device in aerosol spray device has a propellant and an active solution, with independent flow paths. The active solution may be the composition disclosed herein. A venturi system is configured to atomize the active solution via the propellant and project the active solution in a dispersion area around the device. An actuation mechanism is configured to actuate the propellant flow path and create a continuous activation flow for the aerosol spray device. By separating the propellant and the active solution within the aerosol spray device, the venturi system facilitates increased control of the atomization and projection of the active solution.

In addition to the venturi system described above, the insecticide composition can be atomized using other dispensing systems including traditional aerosol dispensers or cans that use propellant, manual trigger spray bottles and dispensers, fans, ultrasonic devices, vibration devices, piezoelectric devices, pumping the composition through nozzles to atomize the composition, thermal foggers, cold foggers, and ULV (ultra-low volume) foggers.

In additional embodiments, the dispensers may be manual, automated, timed, electric, or battery operated. Automatic aerosol dispensers release a steady stream of insecticide at pre-set intervals. Automatic dispensers may be especially useful for rooms or greenhouses with constant pests, rather than sporadic infestations. Automatic dispensers are also easily installed into a space or room, and can be easily programmed to release the composition disclosed herein during off-hours when humans are not present, reducing any risk of exposure or inhalation. Battery operated dispensers may be used in outdoor spaces, or areas without outlets/electricity. They are similar in design to electric dispensers but use batteries to power the fan.

The insecticide composition and dispenser can be formulated for single use or multi-use applications. Single use embodiments can be designed with a volume of product sufficient for one use. Additionally, the packaging may be designed so that it cannot be reused once it has dispensed the product. An example of a single use package is an aerosol can that is consumed with one treatment. Multi-use embodiments contain enough composition for more than one treatment. In some embodiments, if successive treatments are needed to treat an infestation, the multi-use product may include enough product to complete all the treatments. Such multi-use may be refillable or intended to be discarded once the composition has been consumed.

Diffusion systems are especially helpful for eliminating an insect infestation because it allows for better distribution of an insecticide throughout a room with places where insects can hide such as places that are up high, down low, or behind large objects. These are places that are easy to miss if spraying or hand applying an insecticide or that would be time-consuming for a person to try to reach by hand. If a room is not thoroughly treated, it creates an opportunity for any insects that were not treated to prolong the infestation.

The insecticide composition disclosed herein may be used in an indoor, or outdoor space. In one embodiment, the composition may be diffused indoors, in a space of about 1,000 square feet to about 5,000 square feet. The insecticide composition is most efficacious at temperatures from about 15.5° C. to about 32.2° C. The larger the room, the greater the amount of the composition needed to produce an effective concentration to kill targeted pests.

In another embodiment, the insecticide composition may be used in a diffuser system outdoors. Several factors affect the application of the insecticide composition in outdoor environments, including temperature, wind conditions, the size of the outdoor space being treated, and considerations such as foliage or highly wooded areas where even diffusion of the composition may be more difficult. In outdoor spaces, the duration of effect may be shorter, depending again on weather conditions, such as wind.

In embodiments, the placement of the insecticide diffuser, dispenser, or fogger within a room can significantly impact its effectiveness in controlling pests. The dispenser could be placed in an area where the insects are likely to travel, such as near doors, windows, and other entry points. Alternatively, the dispenser could be placed in the center of a room so that the insecticide composition can be evenly distributed throughout the space. In addition, the size of the room and the type of dispenser being used should be considered. For example, if using an aerosol dispenser, it should be placed at a height that allows for the insecticide to disperse evenly throughout the room. If using an electric or battery-operated dispenser, it should be placed in a central location to ensure maximum coverage. Foggers may be placed in a central location, to effectively disseminate a mist that will fill the area. The insecticide dispenser or diffuser should not be placed near sources of heat or flames, such as stoves or heaters, as this can cause the insecticide to ignite or become less effective.

In embodiments, the efficacy of the insecticide composition may be influenced by temperature, and the optimal temperature range may be from about 15.5° C. to about 32.2° C. This temperature range is ideal for the activity and the effectiveness of the insecticide composition disclosed herein, but the insecticide composition may be effective at temperatures ranging outside of the values listed. At lower temperatures, such as below 10° C., the insecticide composition disclosed herein may become less effective, as the cold can slow down the metabolic processes of the pests, which may make them less susceptible to the insecticide. At higher temperatures, such as above 32.2° C., the efficacy of the insecticide composition may also be reduced, as the heat may accelerate the breakdown of the active ingredients, making the insecticide less potent.

The amount of time between diffusion applications may also implicate the efficacy of the insecticide composition. For example, for large infestations of pests, or those where there are various life-stages of a pest present, multiple diffusion applications of the insecticide composition may be required. Conversely, for smaller infestations of pests, a single diffusion application of the insecticide composition may be effective for killing all of the pests present.

In embodiments, once the insecticide composition has been applied by diffusing it into a space, insect death may begin to take place as soon as within 24 hours of releasing the insecticide composition. The diffused composition may remain effective and continue to kill insects after the initial 24 hours of release. The duration of efficacy, and the level of efficacy may be dependent on the formula used (see example formulas in Table 2). For example, a formula with a higher percentage of active ingredients used, may begin to kill insects more quickly, and for a longer time than a formula with a lower, or moderate percentage of active ingredients used.

In embodiments, the duration of time that the treatment lasts, may depend on a variety of factors including, but not limited to, the size of the room or space, whether the room or space is enclosed, the temperature of the room or space, the anticipated number of pests to be killed, and the type of pest. Once the treatment has been started and the insecticide has been diffused into a space, the amount of time between the beginning of the treatment and the time when it is safe for humans or domestic animals to re-enter the space is dependent on the size of the space of diffusion and the amount of insecticide composition released.

In an embodiment, the insecticide composition may be used for cockroaches. The active amount of the composition diffused into a room may be from about 0.0001 g/ft³ to about 0.00075 g/ft³ in a room from about 1,000 square feet to about 5,000 square feet. From beginning the treatment, the diffused insecticide composition may begin killing cockroaches within the first 24 hours, and effectively kill all stages of cockroaches. The efficacy of the insecticide composition may increase to 90% to 100% within about 48 hours to about 72 hours of being dispensed. In some examples, the efficacy of the insecticide composition may increase to 90% to 100% within about 96 hours.

TABLE 1
Formulation of Example 1

| CAS Number | Ingredient | Wt % in formula |
|---|---|---|
| petroleum distillates, | Mineral spirits | 68.9% |
| hydrotreated light | | |
| 64742-47-8 | | |
| 8042-47-5 | Mineral oil | 24.0% |
| Phenothrin | Sumithrin | 4.6% |
| 26002-80-2 | | |
| Piperonyl butoxide | PBO tech. | 2.5% |
| 51-03-6 | | |

Concentrate total = 100.0%

The above table represents an embodiment of the insecticide composition disclosed herein, where the final composition comprises about 4.6% phenothrin, and about 2.5% piperonyl butoxide.

TABLE 2
Formulations of Examples A-J

| | Formula (wt % in conc.) | | | | | | | | | |
|---|---|---|---|---|---|---|---|---|---|---|
| Ingredient | A | B | C | D | E | F | G | H | I | J |
| Mineral | 88.0 | 40.0 | 88.0 | 38.0 | 38.0 | 41.0 | 21.83 | 64.85 | 68.9 | 62.4 |
| spirits | | | | | | | | | | |
| Mineral | — | 51.0 | — | 50.0 | 50.0 | 50.0 | 65.00 | 22.00 | 24.0 | 24.0 |
| oil | | | | | | | | | | |
| Light | | | | | | | 5.00 | 5.00 | | |
| aromatic naptha | | | | | | | | | | |
| Cypermethrin | 8.6 | 8.7 | 8.6 | 8.6 | — | — | — | — | | |
| premix | | | | | | | | | | |
| Tetramethrin | — | — | 1.0 | 1.0 | 1.0 | 1.0 | 1.00 | 1.00 | | |
| PBO tech. | — | — | 2.5 | 2.5 | 2.5 | 2.5 | 2.50 | 2.50 | 2.5 | 5.00 |
| Lambda | — | — | — | — | 8.6 | — | — | — | | |
| cy. Premix | | | | | | | | | | |
| Sumithrin | — | — | — | — | — | 4.3 | 4.30 | 4.30 | 4.3 | 8.60 |

### Examples

Formula A comprises about 88.0% mineral spirits, and about 8.6% Cypermethrin premix.

Formula B comprises about 40.0% mineral spirits, about 51% mineral oil, and about 8.7% Cypermethrin premix.

Formula C comprises about 88.0% mineral spirits, about 8.6% Cypermethrin premix, about 1.0% Tetramethrin, and about 2.5% piperonyl butoxide.

Formula D comprises about 38.0% mineral spirits, about 50.0% mineral oils, about 8.6% Cypermethrin premix, about 1.0% Tetramethrin, and about 2.5% piperonyl butoxide.

Formula E comprises about 38.0% mineral spirits, about 50.0% mineral oils, about 1.0% Tetramethrin, about 2.5% piperonyl butoxide, and about 8.6% lambda cypermethrin premix.

Formula F comprises about 41.0% mineral spirits, about 50.0% mineral oils, about 1.0% Tetramethrin, about 2.5% piperonyl butoxide, and about 4.3% Sumithrin.

Formula G comprises about 21.83% mineral spirits, about 65.00% mineral oils, about 5.00% light aromatic naptha, about 1.00% Tetramethrin, about 2.50% piperonyl butoxide, and about 4.30% Sumithrin.

Formula H comprises about 64.85% mineral spirits, about 22.00% mineral oils, about 5.00% light aromatic naptha, about 1.00% Tetramethrin, about 2.50% piperonyl butoxide, and about 4.30% Sumithrin.

Formula I comprises about 68.9% mineral spirits, about 24.0% mineral oils, about 2.5% piperonyl butoxide, and about 4.3% Sumithrin.

Formula J comprises about 62.40% mineral spirits, about 24.0% mineral oils, about 5.00% piperonyl butoxide, and about 8.60% Sumithrin.

Of the listed examples, formulas E-I exhibited high levels of efficacy. In each of formulas E-I, the solvent systems used were similar in makeup and general amount. Formula I exhibited the highest level of efficacy, with the ability to kill 90% to 100% of insects present, at all life stages.

In tests completed using Formula I, an efficacy of ≥90% was achieved within about 48 to about 72 hours. However, in tests completed using Formula J where nearly two times the active ingredients were used, an efficacy of ≥90% was achieved without about 48 hours in three out of four tests.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

What is claimed:

1. An aerosol spray device comprising:
a canister configured to hold a propellant;
a reservoir configured to hold an active solution, the reservoir discrete relative to the canister;
a manifold body having a first end and a second end defining a first flow path, the first end coupled in fluid communication with the canister;
a venturi nozzle having a first end and a second end defining a second flow path, the first end coupled in fluid communication with the reservoir and the second end supported at least partially within the second end of the manifold body and within the first flow path, wherein the second flow path proximate the second end of the venturi nozzle has a constricted diameter relative to the second flow path proximate the first end of the venturi nozzle; and
an actuator configured to selectively actuate flow of the propellant through the first flow path, wherein upon activation, the propellant is channeled towards the second end of the manifold body and at least partially around an exterior of the second end of the venturi nozzle, and wherein when the propellant expels from the second end of the manifold body, the propellant siphons the active solution through the second flow path and out of the second end of the venturi nozzle such that the active solution is atomized for dispersion from the aerosol spray device.

2. The aerosol spray device of claim 1, wherein the active solution is an insecticide composition comprising:
0.1 wt. % to 20 wt. % of a synthetic pyrethroid;
0.1 wt. % to 10 wt. % of a synergist; and
50 wt. % to 99 wt. % of a solvent.

3. The aerosol spray device of claim 1, further comprising a nozzle cap coupled to the second end of the manifold body, the nozzle cap defining an orifice configured to at least partially receive the second end of the venturi nozzle.

4. The aerosol spray device of claim 1, further comprising a cover configured to couple to an end of the canister, wherein the reservoir, the manifold body, the venturi nozzle, and the actuator, are all at least partially disposed within the cover.

5. The aerosol spray device of claim 1, wherein the propellant is free of volatile organic compounds and wherein the propellant is non-flammable.

6. The aerosol spray device of claim 1, wherein the canister includes between 2 and 3.5 ounces of the propellant.

7. The aerosol spray device of claim 1, wherein the canister is configured to pressurize the propellant to a pressure of from 30 to 120 pounds per square inch.

8. The aerosol spray device of claim 1, wherein the active solution includes at least one active and at least one solvent.

9. The aerosol spray device of claim 8, wherein the active solution includes between 2 and 7 grams of the at least one active.

10. A method of distributing an airborne insecticide composition through an aerosol spray device, the method comprising:
diffusing an insecticide composition, the insecticide composition comprising:
0.1 wt. % to 20 wt. % of phenothrin;
0.1 wt. % to 10 wt. % of piperonyl butoxide; and
50 wt. % to 99 wt. % of a solvent.

11. The method of claim 10, wherein the insecticide composition further comprises a thickener.

12. The method of claim 10, further comprising a surfactant selected from the group consisting of fatty soaps, alkyl sulfates, sulfated oils, ether sulfates, sulfonates, sulfosuccinates, sulfonated amides, isethionates, alkyl sulfonate surfactants, a linear alkylbenzene sulfonic acid, a branched alkylbenzene sulfonic acid a C12-C18 alkylsulfate, C12-C18 alkyl alkoxy sulfate, C12-C18 alkyl methyl ester sulfonate, alkylamine, an alkyl diamine, an alkyl polyamine, a mono- or di-quaternary ammonium salt, a monoalkoxylated amine, a dialkoxylated amine, a monoalkoxylated quaternary ammonium salt, a dialkoxylated quaternary ammonium salt, an etheramine, an amine oxide, an alkoxylated amine oxide and a fatty imidazoline, an alkoxylated alcohol, a dialkoxylated alcohol, an alkoxylated dialkylphenol, an alkylpolyglycoside, an alkoxylated alkylphenol, an alkoxylated glycol, an alkoxylated mercaptan, an alkylamine salt, an alkyl quaternary amine salt, a glyceryl or polyglyceryl ester of a natural fatty acid, an alkoxylated glycol ester, an alkoxylated fatty acid, an alkoxylated alkanolamide, a polyalkoxylated silicone, an N-alkyl pyrrolidone, and combinations thereof.

13. The method of claim 10 further comprising a colorant, wherein the colorant comprises at least one of a dye or a pigment, and wherein the dye or the pigment is selected from the group consisting of titanium oxide, titanium dioxide, zinc oxide, an azo-type colorant, a condensate-type colorant, a phthalocyanine-type colorant, a quinacridone-type colorant, an insoluble lake pigment, alizarin dyes, azo dyes, metal phthalocyanine dyes, and combinations thereof.

14. The method of claim 10 further comprising a fragrance selected from the group consisting of: fruit ester, damascenone, alpha-ionone, beta-ionone, raspberry ketone, furanone derivative, limonene, linalool, phenylacetaldehyde, 2-phenylethanol, maltol, vanillin, eugenol, anethol, anise alcohol, anisaldehyde, guajakol, cinnamyl alcohol, cinnamaldehyde, citral, citronellal, citronellol, nerol, geraniol, ethylvanillin, benzyl alcohol, anisaldehyde, cinnamyl ester, benzyl ester, damascene, diacetyl, dihydrocoumarin, beta-dihydroionone, dimethyl anthranilate, methyl anthranilate, ethylmalton, heliotropin, cis-3-hexenyl ester, ethyl decadienoate, methyl dihydrojasmorvate, methyl cinnamate, ethyl cinnamate, p-mentha-8-thiol-3-one, rose oxide, ketoisophorone, and combinations thereof.

15. The method of claim 10, wherein the composition is distributed by diffusion using a propellant for the diffusion of the composition.

16. The method of claim 15, wherein the propellant is selected from the group consisting of: argon, butane, carbon dioxide, a chlorofluorocarbon, dimethyl ether, a hydrocarbon, a hydrofluorocarbon, isobutane, nitrogen, propane, and combinations thereof.

17. The method of claim 10, wherein the insecticide composition has a viscosity of about 5 cps to about 200 cps at room temperature.

18. The method of claim 10, wherein the insecticide composition has an efficacy of from 90% to 100% from 48 hours to 72 hours after diffusing the insecticide composition.

19. The method of claim 10, wherein the insecticide composition is effective against a variety of pests, and wherein the pests include at least one of cockroaches, fleas, ticks, mosquitos, flies, and combinations thereof.

20. The method of claim 10, wherein the insecticide composition is diffused as at least one of an aerosol, a mist, an oil diffusion, a fog, or a vapor.
